(19) United States
(12) Patent Application Publication
(10) Pub. No.: US 2026/0319285 A1
(43) Pub. Date: Oct. 15, 2026

(54) DISPLAY DEVICE

(71) Applicant: LG Display Co., Ltd., Seoul (KR)

(72) Inventor: Woong Jin SEO, Paju-si (KR)

(73) Assignee: LG Display Co., Ltd., Seoul (KR)

(21) Appl. No.: 19/463,531

(22) Filed: Jan. 29, 2026

(30) Foreign Application Priority Data
Feb. 5, 2025 (KR) 10-2025-0014666

(51) Int. Cl. G02F 1/133; G02F 1/1335; G09G 3/36; H04N 23/667

(52) U.S. Cl. CPC G02F 1/13312; G02F 1/133514; G09G 3/36; H04N 23/667; G09G 2320/0626; G09G 2360/144

(57) ABSTRACT

A display device can include a display panel having a first display area and a second display area, a sensor configured to receive light via the second display area, a first light source module configured to supply light to the first display area, and a second light source module configured to supply light to the second display area. The second display area is operated in a sensing mode in which light is incident on the sensor by frame during an operation of the sensor and in a sub-display mode in which an image is displayed.

### CROSS-REFERENCE TO RELATED APPLICATION

This application claims priority to and the benefit of Korean Patent Application No. 10-2025-0014666, filed in the Republic of Korea on Feb. 05, 2025, the disclosure of which is hereby expressly incorporated by reference in its entirety.

### BACKGROUND

### Field

Embodiments of the present disclosure relate to a display device.

### Discussion of the Related Art

With the development of the information society, there is an increasing demand for a display device for displaying an image in various forms. Recently, various display devices such as a liquid crystal display (LCD), a plasma display panel (PDP), and an organic light emitting display (OLED) have been utilized.

In recent years, a multimedia function of an electronic apparatus such as a mobile terminal has been improved. For example, there is a tendency that a camera is basically embedded in a mobile terminal and the resolution of the camera is being increased up to an existing digital camera. Meanwhile, a front camera of the mobile terminal restricts screen design to hinder the screen design. To reduce a space occupied by the camera, screen design including a notch or a punch hole has been adapted; however, a screen size can still be restricted due to the camera and implementation of a full-screen display can be difficult.

To implement the full-screen display, a method in which an imaging area where pixels are disposed is prepared in a screen of a display panel, and a camera and/or various sensors are disposed in the imaging area has been suggested. However, because an image is not implemented in the imaging area during photographing with the camera, there can be a problem in that the imaging area or the camera is visible from the outside.

### SUMMARY OF THE DISCLOSURE

Embodiments of the present disclosure provide a display device capable of implementing a full-screen display during driving of a camera.

Embodiments of the present disclosure provide a display device in which a problem that an imaging area is visible during driving of a camera is improved.

The problems addressed by the embodiments of the present disclosure are not limited to those described above, and other problems not described will be clearly understood by those skilled in the art from the following description.

A display device according to an aspect of the present disclosure includes a display panel including a first display area and a second display area; a sensor configured to receive a light via the second display area; a first light source module configured to supply light to the first display area; and a second light source module configured to supply light to the second display area, in which the second display area is operated in a sensing mode in which light is incident on the sensor by frame during an operation of the sensor and a sub-display mode in which an image is displayed. For example, the second display area can be operated in one of the sending mode and the sub-display mode.

According to aspects of the present disclosure, when the sensor is not operated, the first display area and the second display area can be operated in a normal mode in which an image is displayed, and when the sensor is operated, the first display area can be operated in the normal mode and the second display area can be operated alternately in the sensing mode and the sub-display mode by frame.

According to aspects of the present disclosure, the display device can further include a data driver configured to drive the display panel; a sensor controller configured to control the sensor; a first light source driver configured to drive the first light source module; and a second light source driver configured to drive the second light source module, in which the data driver, the sensor controller, and the second light source driver can be synchronized to drive the second display area of the display panel, the sensor, and the second light source module by frame.

According to aspects of the present disclosure, the data driver can adjust transmittance of liquid crystal such that transmittance of the second display area becomes a maximum in the sensing mode, and can adjust the transmittance of the liquid crystal in the sub-display mode such that the second display area implements an image.

According to aspects of the present disclosure, the sensor can be configured to generate an image using light received in a sensing mode period.

According to aspects of the present disclosure, the second light source module can be turned off in a sensing mode period and can be turned on in a sub-display mode period.

According to aspects of the present disclosure, luminance of light that is emitted from the second light source module in the sub-display mode can be higher than luminance of light that is emitted from the second light source module in a normal mode.

According to aspects of the present disclosure, a period during which the second light source module is turned on in the sub-display mode can be shorter than one frame period.

According to aspects of the present disclosure, the first light source module can be operated in the normal mode to output an image when the second light source module is operated in the sensing mode.

According to aspects of the present disclosure, the display panel can include a first substrate, a second substrate, and a liquid crystal layer disposed between the first substrate and the second substrate.

According to aspects of the present disclosure, the display device can further include a color filter disposed on the display panel, in which the color filter disposed in the second display area can include a filter area where an image is implemented and a transmission area where an image is not implemented.

According to aspects of the present disclosure, the second display area can allow external light to flow therein via the transmission area in the sensing mode and can implement an image via the filter area in the sub-display mode.

According to aspects of the present disclosure, the first light source module can include a light guide member disposed in the first display area; a plurality of first light sources that irradiate the light guide member with light; an optical sheet disposed above the light guide member; and a reflector disposed below the light guide member, the optical sheet can include a first opening hole disposed in a portion corresponding to the first display area, and the reflector can include a second opening hole disposed in a portion corresponding to the second display area.

According to aspects of the present disclosure, the second light source module can include a path conversion member disposed in the second display area; and a second light source disposed on one side of the path conversion member.

According to aspects of the present disclosure, the path conversion member can be disposed to overlap the light guide member in the second display area.

According to aspects of the present disclosure, the display device can further include an illuminance sensor, in which, when determination is made to be a low illuminance as a sensing result of the illuminance sensor, a sensing mode period can be set to be longer than a sub-display mode period.

According to aspects of the present disclosure, it is possible to overcome or address a problem that an imaging area or a camera is visible from the outside, by implementing an image in the imaging area during driving of the camera.

According to aspects of the present disclosure, it is possible to reduce or minimize light interference by turning off a light source module in the sensing mode during an operation of the camera.

Various and beneficial advantages and effects of the present disclosure are not limited to the above, and can be more easily understood in the course of describing specific embodiments of the present disclosure.

### BRIEF DESCRIPTION OF THE DRAWINGS

The above and other objects, features, and advantages of the present disclosure will become more apparent to those of ordinary skill in the art by describing example embodiments of the present disclosure thereof in detail with reference to the attached drawings, in which:

FIG. 1 is a conceptual view of a display device according to an embodiment of the present disclosure;

FIG. 2 is an exploded perspective view of the display device according to the embodiment of the present disclosure;

FIG. 3 is a cross-sectional view of the display device according to the embodiment of the present disclosure;

FIG. 4 is a diagram illustrating a second light source module according to the embodiment of the present disclosure;

FIG. 5 is a diagram illustrating a color filter in a first display area and a second display area according to the embodiment of the present disclosure;

FIG. 6 is a cross-sectional view of a display device according to another embodiment of the present disclosure;

FIG. 7 is a diagram illustrating a light guide member according to another embodiment of the present disclosure;

FIG. 8 is a flowchart illustrating a method for driving a display panel, a light source module, and a sensor according to the embodiment of the present disclosure;

FIG. 9 is a diagram illustrating a method for driving the display panel, a first light source module, a second light source module, and the sensor in a normal mode of the display device according to the embodiment of the present disclosure;

FIG. 10 is a diagram illustrating a method for driving the display panel, the second light source module, and the sensor in a camera mode of the display device according to the embodiment of the present disclosure;

FIG. 11 is a diagram illustrating an operation of a color filter in a sensing mode according to the embodiment of the present disclosure;

FIG. 12 is a diagram illustrating an operation of the color filter in a sub-display mode according to the embodiment of the present disclosure;

FIG. 13 is a modified example of FIG. 10 according to an embodiment of the present disclosure;

FIG. 14 is a block diagram of a display device according to another embodiment of the present disclosure display device;

FIG. 15 is a diagram illustrating a method for driving a display panel, a second light source module, and a sensor in a camera mode according to another embodiment of the present disclosure; and

FIG. 16 is a diagram illustrating an electronic product to which the display device according to another embodiment of the present disclosure is applied.

### DETAILED DESCRIPTION OF THE EMBODIMENTS

Hereinafter, example embodiments of the present disclosure will be described in detail with reference to the accompanying drawings.

However, the technical idea of the present disclosure is not limited to some of the described embodiments, but can be implemented in various different forms, and one or more of the components among the embodiments can be used being selectively coupled or substituted without departing from the scope of the technical idea of the present disclosure.

In addition, terms (including technical and scientific terms) used in the embodiments of the present disclosure can be construed as meaning that can be generally understood by those skilled in the art to which the present disclosure pertains unless explicitly specifically defined and described, and the meanings of the commonly used terms such as terms defined in a dictionary can be construed in consideration of contextual meanings of the related technologies.

In addition, the terms used in the embodiments of the present disclosure are for describing the embodiments and are not intended to limit the present disclosure.

In the present specification, a singular form can include a plural form unless specified in the phrase, and when described as "at least one (or one or more) of A, B, and C", one or more among all possible combinations of A, B, and C can be included.

In addition, the terms such as first, second, (a), and (b) can be used to describe the components of the embodiments of the present disclosure.

These terms are only for the purpose of distinguishing one component from another component, and the nature, sequence, order, or the like of the corresponding components is not limited by these terms.

In addition, when a certain component is described as being "connected", "coupled", and/or "joined" to another component, it can include not only a case in which the certain component is directly connected, coupled, or joined to another component, but also a case where the certain component is "connected", "coupled", or "joined" to another component by other components between the certain component and another component. Further, the term “can” fully encompasses all the meanings and coverages of the term “may” and vice versa.

In addition, when each component is described as being formed or disposed "on (above)" or below (under)" another component, for example, it can include not only a case where the two components are in direct contact with each other, but also a case where one or more other components are formed or disposed between the two components. In addition, when described as "on (above)" or "below (under)", it can include the meanings of not only an upward direction but also a downward direction with one component as a reference.

Now, the features of various embodiments of the present disclosure will be described referring to the figures. All the components of each display device/apparatus according to all embodiments of the present disclosure are operatively coupled and configured.

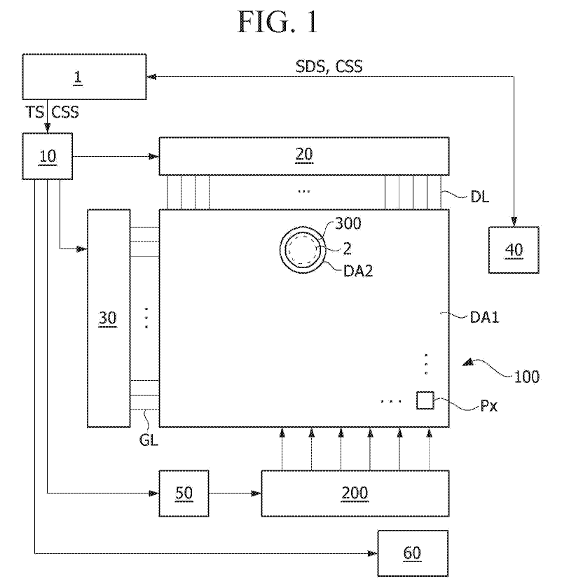

FIG. 1 is a conceptual view of a display device according to an embodiment of the present disclosure.

Referring to FIG. 1, the display device according to the embodiment includes a display panel 100 including a first display area DA1 where an image is displayed according to input image data and a second display area DA2, light source modules 200 and 300 that supply light to the display panel 100, and a sensor 2 that receives light. The display device includes a plurality of drivers and controllers that control the display panel 100, the light source module 200 and 300, and the sensor 2.

In the display panel 100, pixels Px are defined by intersections of a plurality of gate wires GL and a plurality of data wires DL, and each pixel can include a thin film transistor and a storage capacitor.

The thin film transistor can be switched in response to a scan signal supplied via the gate wire GL, and when the thin film transistor is turned on, image data (data voltage) supplied via the data wire DL can be supplied to the pixel.

The display panel 100 can include a pixel electrode that applies the data voltage to the pixel and a common electrode that applies a common voltage. The pixel electrode can be disposed on a lower substrate, and the common electrode can be disposed on an upper substrate.

The display panel 100 can be a liquid crystal panel including a liquid crystal layer. The display panel 100 is configured such that an alignment state of liquid crystal is changed by an electric field between the data voltage and the common voltage, and can implement an image by adjusting the alignment of the liquid crystal to adjust transmittance of light supplied from the light source module. However, embodiments of the present disclosure are not limited thereto. For example, the display panel 100 can be a display panel including an organic light emitting element or an inorganic light emitting element.

The display panel 100 can include the first display area DA1 where an image is displayed and the second display area DA2. The second display area DA2 can be defined as an area below which the sensor 2 is disposed. Alternatively, the second display area DA2 can be defined as an area where the sensor 2 disposed below the display panel 100 receives light. The second display area DA2 can have various shapes such as a circular shape, an elliptical shape, or a polygonal shape. The second display area DA2 can be smaller in size than the first display area DA1, but embodiments of the present disclosure are not limited thereto.

Each of the first display area DA1 and the second display area DA2 includes pixels Px, thereby implementing a full-screen display. According to the embodiment, the first display area DA1 is operated only in a normal mode in which an image is displayed, while the second display area DA2 can be operated in a sub-display mode in which an image is displayed and a sensing mode in which external light is received.

The light source module 200 and 300 can include a first light source module 200 that supplies light to the first display area DA1 and a second light source module 300 that supplies light to the second display area DA2.

The first light source module 200 can be controlled by a first light source driver 50, and the second light source module 300 can be controlled by a second light source driver 60. The first light source module 200 and the second light source module 300 can be turned on or off simultaneously or can be turned on or off at different timings.

At least one sensor 2 can be disposed in the second display area DA2. The sensor 2 can receive light that is incident on the second display area DA2. The sensor 2 can include various sensors that receive light such as an RGB camera, an illuminance sensor, and an infrared camera.

The sensor controller 40 can generate an image or a three-dimensional feature map using light incident on the sensor 2. For example, the sensor 2 can be an RGB camera or an infrared camera. For example, the sensor 2 can include both an RGB camera and an infrared camera.

A system part 1 can supply image data and signals necessary for driving such as a timing signal TS to a timing controller 10. The timing signal TS can include a clock signal, horizontal and vertical synchronization signals, gate and data enable signals, and the like.

The system part 1 can receive a sensor driving signal SDS from the sensor controller 40. The system part 1 can transmit an imaging synchronization signal CSS and a control signal to a data driver 20, the sensor controller 40, and the second light source driver 60 to generate an image according to the sensor driving signal SDS. Accordingly, the data driver 20, the sensor controller 40, and the second light source driver 60 can be synchronized and operated in a camera mode. However, embodiments of the present disclosure are not limited thereto. The timing controller 10 can receive the control signal of the system part 1 and can transmit the control signal and the imaging synchronization signal CSS to the data driver 20, the second light source driver 60, and the sensor controller 40.

The timing controller 10 can generate a gate control signal for controlling a gate driver 30 and a data control signal for controlling the data driver 20 using the timing signal TS transmitted from the system part 1.

The timing controller 10 can convert the image signal transmitted from the system part 1 into digital image data (R, G, B) in units of frame and can supply the digital image data to the data driver 20. The gate control signal is supplied to the gate driver 30, and the data control signal is supplied to the data driver 20.

The gate driver 30 generates scan signals for driving the thin film transistors formed in the respective pixels Px of the display panel 100 on the basis of the gate control signal supplied from the timing controller 10. The generated scan signals are sequentially supplied to the plurality of gate wires GL.

The data driver 20 can sequentially receive the digital image data (R, G, B) supplied from the timing controller 10, can convert the digital image data into a data voltage with reference to a reference voltage, and can supply the data voltage to each pixel of the display panel 100.

The system part 1 can supply a light source control signal to the first light source driver 50 and the second light source driver 60. The first light source driver 50 and the second light source driver 60 can supply a light source driving signal according to the light source control signal to the first light source module 200 and the second light source module 300. The light sources of the first light source module 200 and the second light source module 300 can be turned on in response to the light source driving signal to generate light.

The light source can be a light emitting diode (LED), an exterior electrode fluorescent lamp (EEFL), a cold cathode fluorescent lamp (CCFL), a laser diode, or the like, but embodiments of the present disclosure are not limited thereto.

The light source control signal can include an LED enable signal and a pulse width modulation (PWM) signal, and the like. The LED enable signal can serve to control a timing of turning on and off the light source. For example, when the LED enable signal that is applied to the first light source driver 50 and the second light source driver 60 has a high level, the light sources can be turned on. When the LED enable signal that is applied to the first light source driver 50 and the second light source driver 60 has a low level, the light sources can be turned off. Each of the first light source driver 50 and the second light source driver 60 can be an LED driver, but embodiments of the present disclosure are not limited thereto. For example, the first light source driving unit 50 and the second light source driving unit 60 can be drivers for a cold cathode fluorescent lamp.

The sensor controller 40 can process light received by the sensor 2 to generate an image or a three-dimensional feature map. When the sensor driving signal SDS input from the outside is received, the sensor controller 40 can transmit the sensor driving signal SDS to the system part 1.

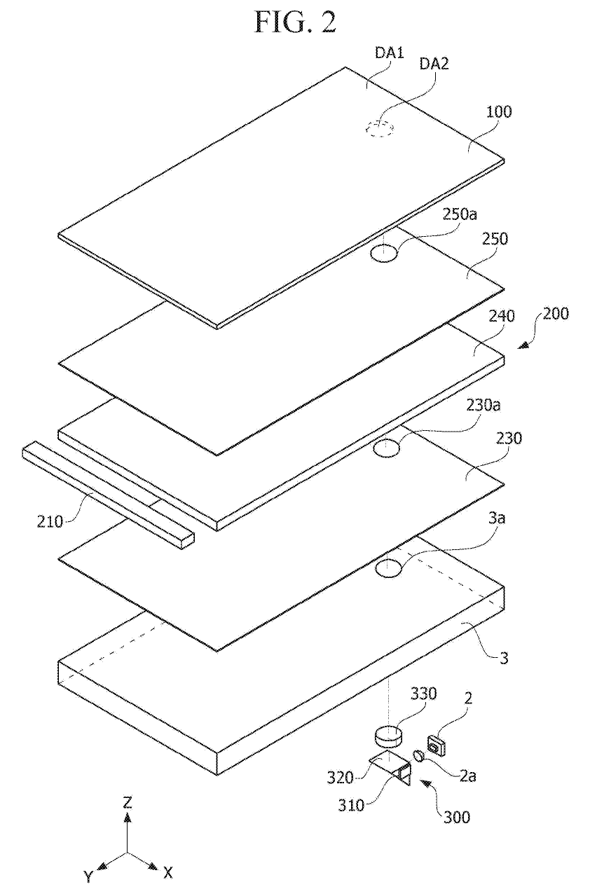

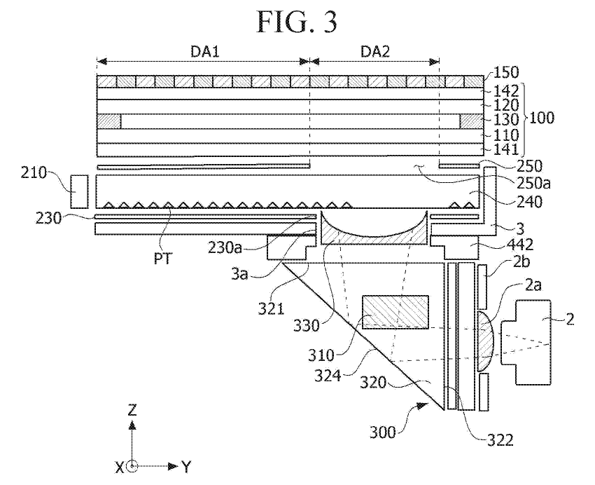

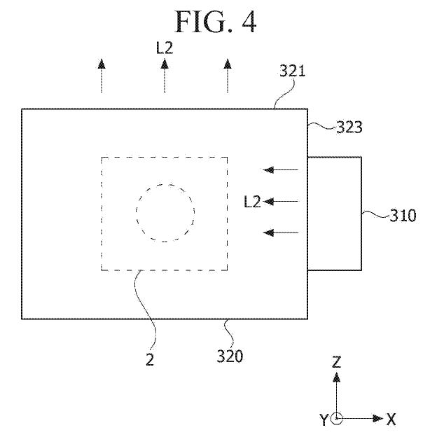

FIG. 2 is an exploded perspective view of the display device according to the embodiment of the present disclosure. FIG. 3 is a cross-sectional view of the display device according to the embodiment of the present disclosure. FIG. 4 is a diagram illustrating the second light source module according to the embodiment of the present disclosure.

Referring to FIGS. 2 and 3, the display device can include a case 3, the first light source module 200 disposed on the case 3, the display panel 100 disposed on the first light source module 200, and the second light source module 300 disposed below the first light source module 200.

The first light source module 200 can be disposed on the case 3 and can include a light guide member 240, a first light source 210 disposed on one side of the light guide member 240, a reflector 230 disposed below the light guide member 240, and a plurality of optical sheets 250 disposed on the light guide member 240. The first light source 210 can include a plurality of light-emitting elements arranged in one direction.

The light guide member 240 can convert light emitted from the first light source 210 into a surface light source. The light guide member 240 can be defined as an optical guiding plate or an optical guiding member. Light emitted from the first light source 210 can be incident on one side of the light guide member 240 and can proceeds to the other side. Light can be reflected inside the light guide member 240 and can be emitted toward the display panel 100. Accordingly, uniform light can be emitted from an upper surface of the light guide member 240.

According to the embodiment, the light guide member 240 can have a plurality of patterns PT disposed in an area corresponding to the first display area DA1. Light can be emitted from the light guide member 240 by the plurality of patterns PT. However, the light guide member 240 may not have a plurality of patterns PT in an area corresponding to the second display area DA2. Accordingly, while the first light source module 200 can be disposed to overlap the first display area DA1 and the second display area DA2, light can be totally reflected in a portion corresponding to the second display area DA2. Therefore, the first light source module 200 may not supply light to the second display area DA2. For example, light from the first light source module 200 may not be emitted in the second display area DA2.

The plurality of optical sheets 250 can condense or diffuse light emitted from the light guide member 240 and can form a uniform surface light source. The plurality of optical sheets 250 can include a prism sheet and/or a diffusion sheet.

The plurality of optical sheets 250 can have a first opening hole 250a formed in a portion corresponding to the second display area DA2. The reflector 230 can have a second opening hole 230a formed in a portion corresponding to the second display area DA2. Accordingly, external light that is incident on the second display area DA2 can pass through the first opening hole 250a and the second opening hole 230a and can be incident on the second light source module 300.

Referring to FIGS. 3 and 4, the second light source module 300 can include a path conversion member 320 on which external light is incident and at least one second light source 310 that supplies light to the path conversion member 320. The path conversion member 320 can have a triangular cross-section, but embodiments of the present disclosure are not limited thereto. For example, the path conversion member 320 can have a polygonal cross-section.

The path conversion member 320 can include a reflection surface 324 that reflects external light such that the external light that is incident on a first side surface 321 of the path conversion member 320 facing the second display area DA2 or the light guide member 240 is incident on the sensor 2. The path conversion member 320 can be disposed to overlap the light guide member 240 in the second display area DA2.

The sensor 2 can be disposed on a second side surface 322 of the path conversion member 320 and can receive external light reflected by the reflection surface 324. A first lens array 2a and 2b may be disposed between the sensor 2 and the second side surface 322 of the path conversion member 320. A second lens 330 that condenses incident light can be disposed above the path conversion member 320. The second lens 330 can be fixed to the case 3 by a bracket 442. The second lens 330 may be inserted in an opening 3a of the case 3.

The second light source 310 can be disposed on a third side surface 323 of the path conversion member 320 in contact with the first side surface 321 and the second side surface 322. The path conversion member 320 can cause light L2 emitted from the second light source 310 to be emitted from the first side surface 321. The path conversion member 320 can include various reflection structures for causing light L2 supplied from the second light source 310 to be emitted from the first side surface 321. For example, the path conversion member 320 can have reflective coating layers formed on remaining side surfaces such that light can only pass through the first side surface 321, the second side surface 322, and the third side surface 323 among a plurality of side surfaces.

The third side surface 323 of the path conversion member 320 can be disposed not to face the second side surface 322 and the reflection surface 324. Accordingly, because the second light source 310 does not block a path of incident external light, the sensor 2 can receive a sufficient amount of light.

The display panel 100 can include a first substrate 110, a second substrate 120, and a liquid crystal layer 130 disposed between the first substrate 110 and the second substrate 120. A first polarizer 141 can be disposed below the first substrate 110, and a second polarizer 142 can be disposed above the second substrate 120. A color filter 150 can be disposed above the second substrate 120.

An optical axis of the first polarizer 141 and an optical axis of the second polarizer 142 can be perpendicular to each other. Light that passes through the first polarizer 141 can be changed in optical axis by the liquid crystal layer 130 and can pass through the second polarizer 142. When a voltage is applied to the pixel electrode disposed on the first substrate 110 and the common electrode disposed on the second substrate 120, an electric field can be formed in the liquid crystal layer 130 and liquid crystal can be rotated. The transmittance of light passing through the display panel 100 can be adjusted according to a degree of rotation of the liquid crystal in the liquid crystal layer 130. As the configurations of the polarizer and the display panel 100, the configuration of a known liquid crystal display panel can be applied without limit.

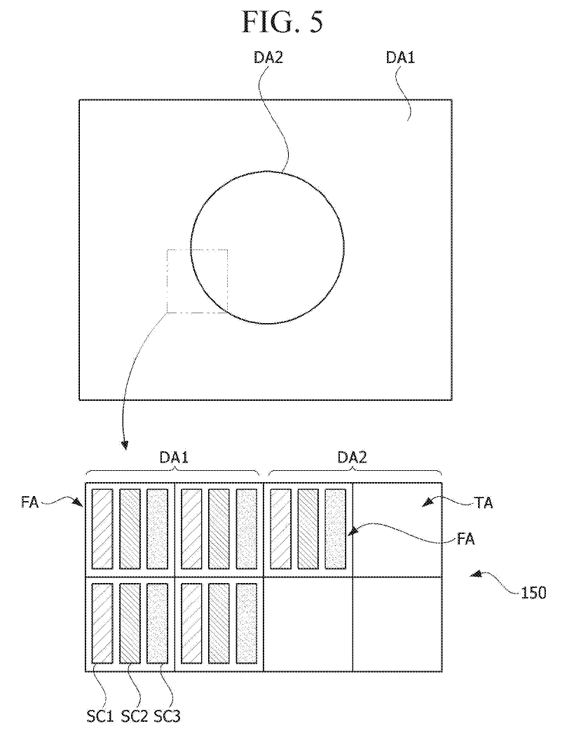

FIG. 5 is a diagram illustrating color filer in a first display area and the second display area according to the embodiment of the present disclosure.

Referring to FIG. 5, the color filter 150 can be different in arrangement between the first display area DA1 and the second display area DA2. The color filter 150 can have sub-color filters SC1, SC2, and SC3 disposed for each sub-pixel in the first display area DA1. The color filter 150 can have sub-color filters SC1, SC2, and SC3 disposed for some pixels and may not have sub-color filters SC1, SC2, and SC3 for other pixels in the second display area DA2. A portion in which the sub-color filters SC1, SC2, and SC3 are not disposed can serve as a transmission area TA on which light is incident or through which light is transmitted.

According to the embodiment, the color filter 150 can include a filter area FA and a transmission area TA in the second display area DA2. The filter area FA can be an area where the sub-color filters SC1, SC2, and SC3 disposed and an image is implemented through color-conversion of light passing through the display panel 100. The transmission area TA can be an area in which, because the sub-color filters SC1, SC2, and SC3 are not disposed, an image is not implemented, and through which light is transmitted. According to the embodiment, because an amount of incidence of external light increases through the transmission area, the performance of the sensor 2 can be improved.

According to the embodiment, while three transmission areas TA can be disposed adjacent to one another for one filter area FA, but embodiments of the present disclosure are not limited thereto. For example, one filter area FA and one transmission area TA can be alternately disposed, and one transmission area TA can be disposed for two filter areas FA. According to the embodiment, the number of filter areas FA and the number of transmission areas TA in the second display area DA2 can be modified in various ways.

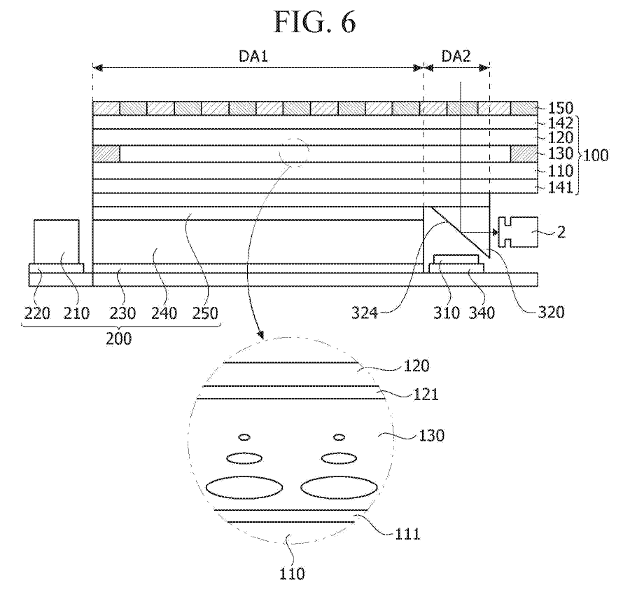

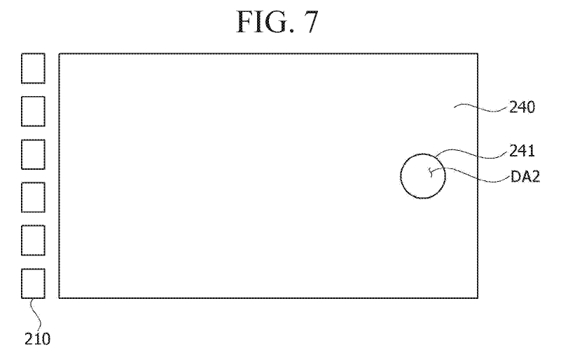

FIG. 6 is a cross-sectional view of a display device according to another embodiment of the present disclosure. FIG. 7 is a diagram illustrating a light guide member according to another embodiment of the present disclosure.

Referring to FIGS. 6 and 7, in the display panel 100, an electric field can be formed by a pixel electrode 111 disposed on the first substrate 110 and a common electrode 121 disposed on the second substrate 120, enabling liquid crystal to rotated. The pixel electrode 111 can be disposed corresponding to each of the sub-color filters SC1, SC2, and SC3 of the color filter 150. Accordingly, transmittance can be adjusted to be different for each sub-pixel to implement a color.

The first light source module 200 can include a first light source 210 disposed on a first circuit board 220, a reflector 230 disposed below a light guide member 240, and a plurality of optical sheets 250 disposed on the light guide member 240.

The second light source module 300 can include at least one second light source 310 disposed on a second circuit board 340 and a path conversion member 320. In the embodiment, while the second light source 310 is drawn as being disposed to face a reflection surface 324 of the path conversion member 320, the second light source 310 can be disposed on one side surface of the path conversion member 320 without facing the reflection surface 324.

The light guide member 240 can have a third opening hole 241 in a portion corresponding to the second display area DA2. Accordingly, light that is incident on the light guide member 240 from the plurality of first light sources 210 may not be emitted to the second display area DA2 in a course of proceeding from one side to the other side.

According to the embodiment, the light guide member 240 of the first light source module 200 may not be disposed to overlap the second display area DA2. Because light that is incident on the second display area DA2 is incident directly on the path conversion member 320 without passing through the light guide member 240, an amount of light can be increased.

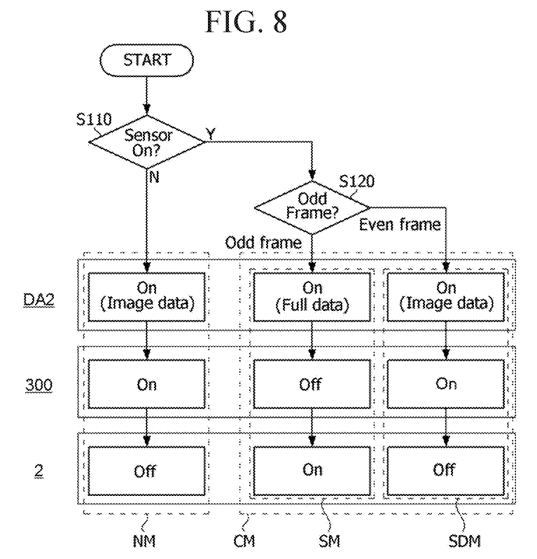

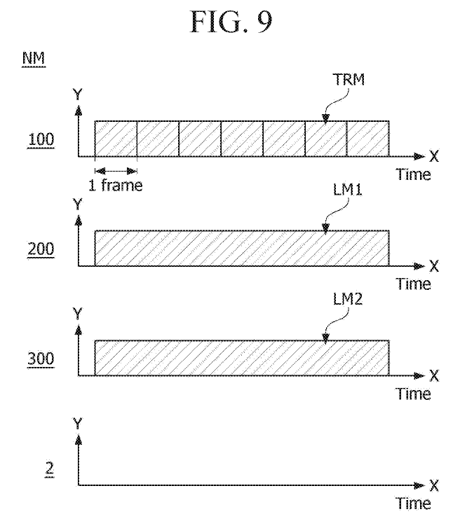

FIG. 8 is a flowchart illustrating a method for driving the second display area of the display panel, the second light source module, and the sensor on the basis of a driving mode according to the embodiment of the present disclosure. FIG. 9 is a diagram illustrating a method for driving the display panel, the first light source module, the second light source module, and the sensor in the normal mode of the display device according to the embodiment of the present disclosure.

Referring to FIG. 8, the display device can drive the second display area DA2 of the display panel 100 in a normal mode NM and a camera mode CM according to whether the sensor is operated (S110). The system part or timing controller can determine that the sensor is operating when it receives a sensor drive signal. The sensor driving signal can be a camera driving signal or an infrared sensor driving signal. When a user clicks an operation button of the sensor 2 or operates a specific event mode (for example, a face ID), the camera driving signal or the infrared sensor driving signal can be output.

When the sensor is not operated, the first display area DA1 and the second display area DA2 can be operated in the normal mode NM. The first display area DA1 can operate in normal mode regardless of sensor operation. In the normal mode NM, the first display area DA1 and the second display area DA2 can output an image.

When the sensor is operated, the display device can operate the second display area DA2 in a sensing mode SM and a sub-display mode SDM by frame (S120).

As the frame, an odd frame and an even frame can be repeatedly output. The odd frame can be an odd-numbered frame, and the even frame can be an even-numbered frame. However, embodiments of the present disclosure are not limited thereto. For example, the odd frame can be an even-numbered frame, and the even frame can be an odd-numbered frame.

According to the embodiment, the second display area DA2 can operate in sensing mode SM in the odd frames and in sub-display mode SDM in the even frames. Accordingly, in the camera mode, an image is output while external light is received. As a result, it is possible to overcome or address a problem that an imaging area is visible from the outside.

In the embodiment, a case where the mode is changed in units of one frame has been described, but embodiments of the present disclosure are not limited thereto. For example, one frame can be divided into a plurality of sub-frames and the mode can be changed by sub-frame. For example, one frame can be divided into a first sub-frame and a second sub-frame in a time division manner, the sensing mode SM can be executed in the first sub-frame, and the sub-display mode SDM can be executed in the second sub-frame.

Referring to FIG. 9, when the normal mode NM is executed, the display panel 100 can apply the voltage to the pixel electrodes of the first display area DA1 and the second display area DA2 to adjust transmittance TRM. As a value of the Y axis becomes greater, light transmittance can become higher.

In the normal mode NM, the first light source module 200 and the second light source module 300 can supply light with luminance LM1 and LM2 determined in advance to the display panel 100. The first light source module 200 can supply light to the first display area DA1, and the second light source module 300 can supply light to the second display area DA2. The sensor 2 may not be operated in the normal mode NM.

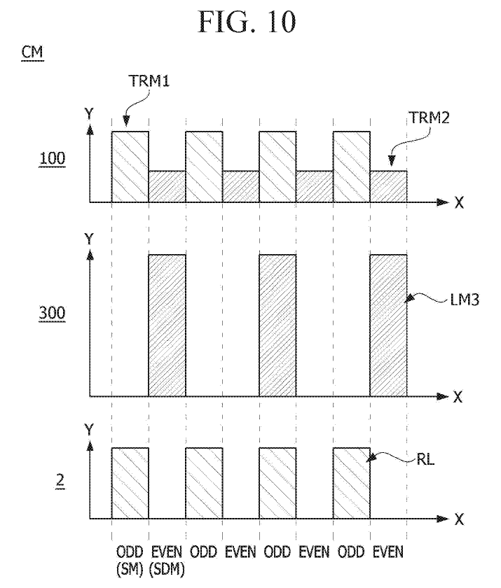

FIG. 10 is a diagram illustrating a method for driving the display panel, the second light source module, and the sensor in the camera mode of the display device according to the embodiment of the present disclosure.

Referring to FIGS. 8 and 10, the second display area DA2 of the display panel 100 can be driven such that light transmittance TRM1 becomes a maximum in the sensing mode SM. As the value of the Y axis becomes greater, light transmittance can become higher.

The data driver 20 that controls the display panel 100 can apply the data voltage to the pixel electrodes of the second display area DA2 such that light transmittance becomes a maximum in the sensing mode SM. To increase light transmittance, the data voltage can be decreased or increased according to the type of the liquid crystal.

The data voltage that is applied to the pixel electrode of the second display area DA2 in the sensing mode SM can be the same. For example, the same data voltage can be applied to the pixels of the second display area DA2 in the sensing mode SM such that light transmittance becomes a maximum. For example, a full data voltage corresponding to a white grayscale can be applied in the sensing mode SM. Accordingly, the liquid crystal layer of the second display area DA2 can be driven so that all incident light is transmitted. However, embodiments of the present disclosure are not limited thereto. For example, a voltage higher or lower than the full data voltage can be applied to increase transmittance in the sensing mode.

The second light source module 300 can be turned off in a sensing mode SM period. Accordingly, because light flowing from the outside is not mixed with light emitted from the second light source module 300, it is possible to minimize noise. The second light source module 300 can be turned on during the sub-display mode SDM. The second light source driver 60 can apply a turn-off signal to the second light source 310 of the second light source module 300 in an odd frame period on the basis of the imaging synchronization signal CSS, and can apply a turn-on signal to the second light source 310 in an even frame period.

The sensor 2 can receive incident light and can perform image processing. According to the embodiment, the sensor 2 can perform image processing on light received during the odd frame period to generate an image or a three-dimensional feature map. As the value of the Y axis becomes greater, an amount RL of received light can be increased.

According to the embodiment, in the sensing mode SM in which the sensor 2 receives light, the light transmittance of the second display area DA2 is adjusted to a maximum and the second light source module 300 does not generate light. Therefore, the sensor 2 can receive sufficient light without noise during the sensing mode period. When the amount of incident light is small, the sensor controller can perform separate image processing to supplement the small amount of incident light.

Hereinafter, the sub-display mode SDM will be described.

In the display panel 100, to output an image in the sub-display mode SDM, light transmittance TRM2 can be adjusted according to image data. While the light transmittance of each pixel in the sensing mode is uniform, the light transmittance of each pixel in the sub-display mode SDM can be different according to an image to be output.

The second light source module can be turned on in a sub-display mode SDM period and can supply light to the display panel 100. Luminance LM3 of light that is supplied from the second light source module 300 in the sub-display mode SDM can be double luminance of light that is supplied in the normal mode NM. Accordingly, an average amount of light that is supplied during a camera mode CM period can be the same as an average amount of light that is supplied in the normal mode NM. Accordingly, also in the camera mode CM period, the same luminance as in a normal mode NM period.

According to the embodiment, in the sensing mode SM, external light is not received, and light can be received or an image can be displayed by frame. Accordingly, since an image output is also output in the sensing mode SM, it is possible to overcome or address the problem that the camera is visible from the outside.

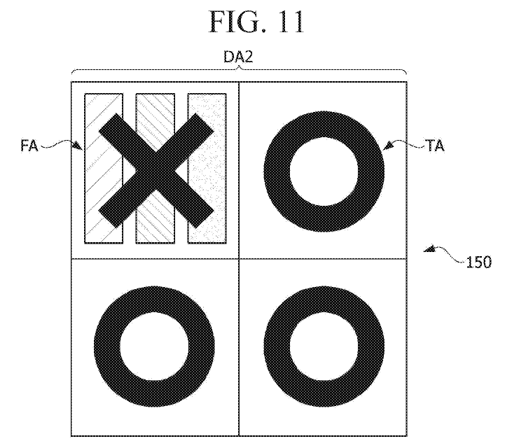

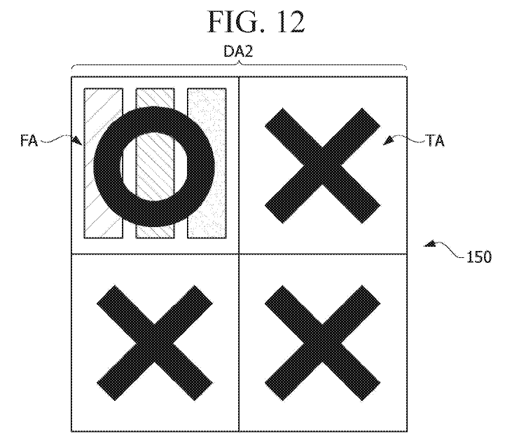

FIG. 11 is a diagram illustrating an operation of the color filter in the sensing mode according to the embodiment of the present disclosure. FIG. 12 is a diagram illustrating an operation of the color filter in the sub-display mode according to the embodiment of the present disclosure.

Referring to FIG. 11, the color filter 150 disposed in the second display area DA2 can include the filter area FA where an image is implemented and the transmission area TA through which light is transmitted. The second display area DA2 of the display panel 100 can drive an area corresponding to the transmission area TA with maximum light transmittance in the sensing mode SM such that external light is transmitted through the transmission area TA of the color filter 150. In this case, the filter area FA can be blocked such that light is not transmitted therethrough. In the color filter 150, a portion attached with O is an area through which light is transmitted with the data voltage adjusted, and a portion attached with X is an area through which light is not transmitted.

When light is incident via the filter area FA, a color can be changed while passing through the color filter and can act as noise. Accordingly, when the sensing mode SM is executed, the filter area FA can be blocked. However, embodiments of the present disclosure are not limited thereto. For example, the data driver 20 can perform control such that external light is transmitted through not only the transmission area TA but also the filter area FA of the second display area DA2 in the sensing mode SM.

Referring to FIG. 12, to implement an image in the sub-display mode SDM, in the display panel 100, light transmittance of an area corresponding to the filter area FA can be adjusted. In this case, light can be blocked in the transmission area TA where an image is not able to be implemented. In the color filter 150, a portion attached with O is an area through which light is transmitted, and a portion attached with X is an area through which light is not transmitted.

However, embodiments of the present disclosure are not limited thereto. For example, the display panel 100 can adjust luminance by performing control such that light is transmitted through not only the filter area FA but also the transmission area TA of the second display area DA2 in the sub-display mode. According to the embodiment, during the sub-display mode SDM period, an image can be implemented in the filter area FA, and luminance can be adjusted in the transmission area TA.

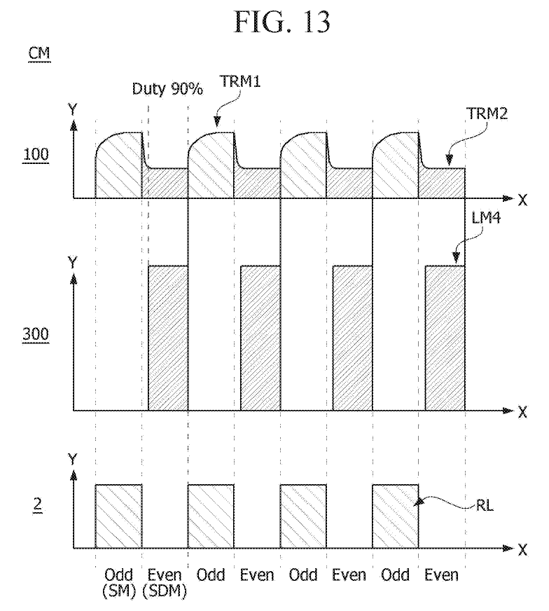

FIG. 13 is a modified example of FIG. 10 according to an embodiment of the present disclosure.

Referring to FIG. 13, the liquid crystal can be driven by the electric field of the pixel electrode and the common electrode, and when the electric field is removed, the liquid crystal can be restored to an original position. However, even when the electric field is removed, a predetermined time delay can occur until the liquid crystal is restored to an original state.

When the even frame starts after the odd frame ends, the liquid crystal may not complete restoration to the original position. Accordingly, when light is output from the second light source module 300 simultaneously with beginning of the even frame, part of light can pass through the display panel 100 and a desired image may not be implemented. Specifically, if light is output from the second light source module 300 simultaneously with beginning of the even frame, a portion of the light can pass through the display panel 100 with an undesirable transmittance (e.g., the maximum transmittance during the sensing mode SM period), so that a desired image may not be implemented.

Accordingly, the second light source module 300 can be controlled to be turned on after a given time after the even frame starts, in the even frame in consideration of the delay until the liquid crystal is restored to the original position. For example, the second light source module 300 can be turned on at a duty ratio of 90% with respect to an entire period of the even frame. However, embodiments of the present disclosure are not limited thereto. A period during which the second light source module 300 is turned on during the sub-display mode SDM period can be modified in various ways. For example, the second light source module 300 can be turned on at a duty ratio of 80% with respect to the entire period of the even frame. In this case, to maintain the total luminance to be the same, luminance can be controlled to be higher as much as a time for which the second light source module 300 is turned on is decreased.

For example, when the second light source module 300 is turned on at the duty ratio of 90% with respect to the entire period of the even frame, luminance LM4 of light that is output from the second light source module 300 can be 2.2 times luminance of light in the normal mode NM.

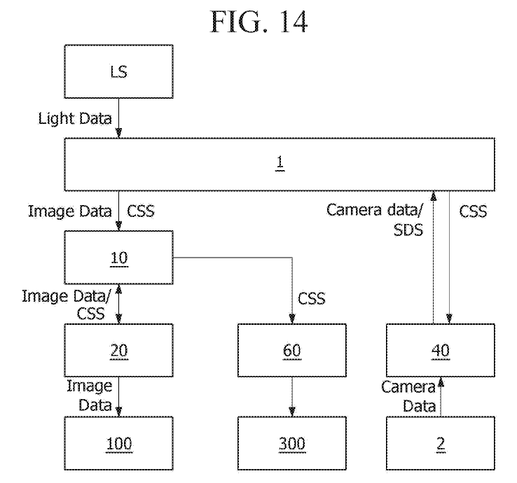

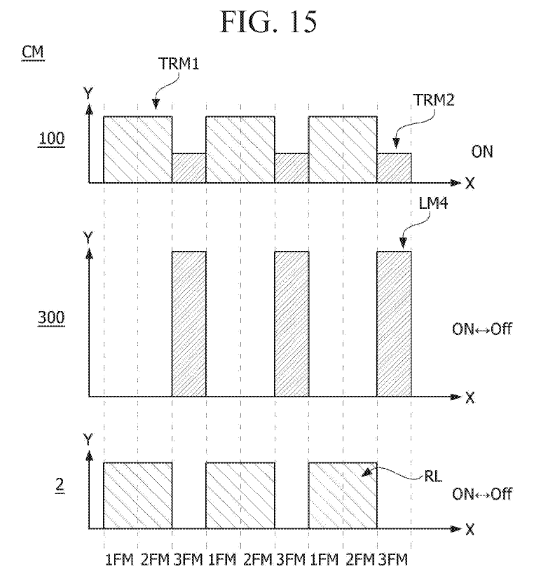

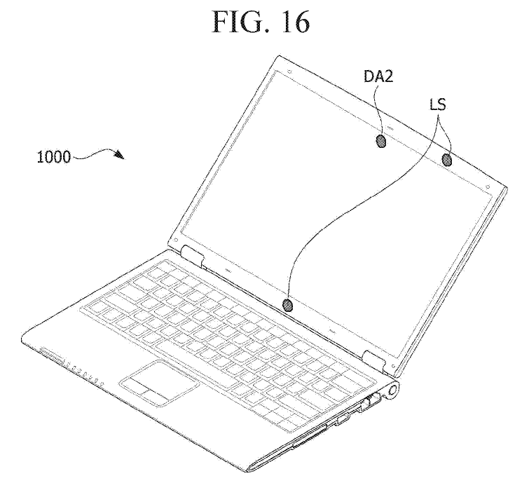

FIG. 14 is a block diagram of a display device according to another embodiment of the present disclosure. FIG. 15 is a diagram illustrating a method for driving a display panel, a second light source module, and a sensor in the camera mode of the display device according to another embodiment of the present disclosure. FIG. 16 is a diagram illustrating an electronic product to which the display device according to another embodiment of the present disclosure is applied.

Referring to FIGS. 14 and 15, the display device according to the embodiment includes a display panel 100 including a first display area DA1 where an image is displayed according to input image data and a second display area DA2, a light source module that supplies light to the display panel 100, and a sensor 2 that receives light. The display device includes a plurality of drivers or controllers that controls the display panel 100, the light source module, and the sensor 2.

In the second display area DA2, at least one sensor 2 can be disposed. The sensor 2 can receive light that is incident on the second display area DA2. The sensor 2 can include various sensors 2 that receive light such as an RGB camera, an illuminance sensor, and an infrared camera. The sensor controller 40 can generate an image or a three-dimensional feature map using light incident on the sensor 2. For example, the sensor 2 can be an RGB camera or an infrared camera. For example, the sensor 2 can include an RGB camera and an infrared camera. According to the embodiment, the sensor 2 can further include an illuminance sensor LS.

A system part 1 can supply an image signal, a timing signal TS, and signals necessary for driving to a timing controller 10. The system part 1 can output a control signal and an imaging synchronization signal CSS to a data driver 20, a second light source driver 60, and a sensor controller 40.

The system part 1 can receive a sensor driving signal SDS from the sensor controller 40 and can control the data driver 20 and the second light source driver 60 according to the sensor driving signal SDS. However, embodiments of the present disclosure are not limited thereto. The timing controller 10 can receive the control signal of the system part 1 and can apply the control signal and the imaging synchronization signal CSS to the data driver 20, the second light source driver 60, and/or the sensor controller 40.

According to the embodiment, when determination is made to be a low illuminance according to a sensing value of the illuminance sensor LS, the system part 1 or the timing controller 10 can increase the sensing mode SM period. For example, the sensing mode SM can be executed in first and second frames 1FM and 2FM, and the sub-display mode SDM can be executed in a third frame 3FM.

When determination is made to be a low illuminance as a sensing result of the illuminance sensor, the system part 1 can set the sensing mode SM period to be longer than the sub-display mode SDM period in the camera mode CM. For example, when a first frame 1FM, a second frame 2FM, and a third frame 3FM are set as a frame group, the sensing mode SM can be executed in the first frame 1FM and the second frame 2FM, and the sub-display mode SDM can be executed in the third frame 3FM. Accordingly, it is possible to secure a sufficient amount of light at the low illuminance by controlling the period of sensing external light to be longer. However, embodiments of the present disclosure are not limited thereto. The sensing mode period can be modified in various ways according to the illuminance. For example, the sensing mode can be executed in four frames, and the sub-display mode can be executed in one frame.

Referring to FIG. 16, an illuminance sensor LS can be disposed in various portions of a display device in an electronic apparatus 1000. The illuminance sensor LS can be disposed in an area adjacent to the second display area DA2 or can be disposed in a keyboard area. In addition, at least one illuminance sensor LS can be disposed in various portions of the display device.

Although the embodiments of the present disclosure have been described in more detail with reference to the accompanying drawings, the present disclosure is not necessarily limited to these embodiments. The present disclosure can be implemented in various modified manners within the scope without departing from the technical idea of the present disclosure.

Accordingly, the embodiments disclosed in the present disclosure are not intended to limit the technical idea of the present disclosure, but to describe the present disclosure, and the scope of the technical idea of the present disclosure is not limited by the embodiments.

Therefore, it should be understood that the embodiments as described above are illustrative and non-limiting in all aspects.

The scope of protection of the present disclosure should be interpreted by the claims, and all technical ideas within the scope of the present disclosure should be interpreted as being included in the scope of the present disclosure.

### LIST OF REFERENCE NUMBERS

10: Timing controller

20: Data driver

30: Gate Driver

40: Sensor controller

50: First light source driver

60: Second light source driver

100: Display panel

200: First light source module

300: Second light source module

What is claimed is:

1. A display device comprising:
a display panel including a first display area and a second display area;
a sensor configured to receive light via the second display area;
a first light source module configured to supply light to the first display area; and
a second light source module configured to supply light to the second display area,
wherein the second display area is operated in a sensing mode in which light is incident on the sensor by frame during an operation of the sensor and a sub-display mode in which an image is displayed.

2. The display device according to claim 1, wherein:
when the sensor is not operated, the first display area and the second display area are operated in a normal mode in which an image is displayed, and
when the sensor is operated, the first display area is operated in the normal mode, and the second display area is operated alternately in the sensing mode and the sub-display mode by frame.

3. The display device according to claim 1, further comprising:
a data driver configured to drive the display panel;
a sensor controller configured to control the sensor;
a first light source driver configured to drive the first light source module; and
a second light source driver configured to drive the second light source module,
wherein the data driver, the sensor controller, and the second light source driver are synchronized to drive the second display area of the display panel, the sensor, and the second light source module by frame.

4. The display device according to claim 1, wherein the display panel is configured to adjust a transmittance of liquid crystal in the sensing mode so that a transmittance of the second display area becomes a maximum, and is configured to adjust the transmittance of the liquid crystal in the sub-display mode so that the second display area implements an image.

5. The display device according to claim 1, wherein the sensor is configured to generate an image using light received in a sensing mode period.

6. The display device according to claim 1, wherein the second light source module is turned off in a sensing mode period and is turned on in a sub-display mode period.

7. The display device according to claim 6, wherein a luminance of light that is emitted from the second light source module in the sub-display mode is higher than a luminance of light that is emitted from the second light source module in a normal mode.

8. The display device according to claim 6, wherein a period during which the second light source module is turned on in the sub-display mode is shorter than one frame period.

9. The display device according to claim 2, wherein the first light source module is operated in the normal mode to output an image when the second light source module is operated in the sensing mode.

10. The display device according to claim 1, wherein the display panel includes a first substrate, a second substrate, and a liquid crystal layer disposed between the first substrate and the second substrate.

11. The display device according to claim 1, further comprising:
a color filter disposed on the display panel,
wherein the color filter disposed in the second display area includes a filter area where an image is implemented and a transmission area where an image is not implemented.

12. The display device according to claim 11, wherein the second display area is configured to allow external light to flow therein via the transmission area in the sensing mode, and implement an image via the filter area in the sub-display mode.

13. The display device according to claim 1, wherein the first light source module includes:
a light guide member disposed in the first display area;
a plurality of first light sources configured to irradiate the light guide member with light;
an optical sheet disposed above the light guide member; and
a reflector disposed below the light guide member,
wherein the optical sheet includes a first opening hole disposed in a portion corresponding to the first display area.

14. The display device according to claim 13,
wherein the reflector includes a second opening hole disposed in a portion corresponding to the second display area.

15. The display device according to claim 14, wherein the second light source module includes:
a path conversion member disposed in the second display area; and
a second light source disposed on one side of the path conversion member.

16. The display device according to claim 15, wherein the path conversion member is disposed to overlap the light guide member in the second display area.

17. The display device according to claim 1, further comprising:
an illuminance sensor,
wherein, when a determination is made to be in a low illuminance as a sensing result of the illuminance sensor, a sensing mode period is set to be longer than a sub-display mode period.

18. The display device according to claim 14, wherein the light guide member includes a third opening hole disposed in the second display area.

19. The display device according to claim 18, wherein the light guide member is disposed to not overlap a path conversion member in the second display area.

20. The display device according to claim 17, wherein when a first frame, a second frame and a third frame are set as a frame group, the sensing mode period corresponds to the first and second frame, and the sub-display mode period corresponds to the third frame.
